(19) United States
(12) Patent Application Publication
(10) Pub. No.: US 2008/0133177 A1
(43) Pub. Date: Jun. 5, 2008

(54) Method for diagnosing an internal combustion engine

(76) Inventors: Martin Klenk, Backnang (DE); Klaus Ries-Mueller, Bad Rappenau (DE); Uwe Kassner, Moeglingen (DE)

Correspondence Address: KENYON & KENYON LLP, ONE BROADWAY, NEW YORK, NY, 10004, US

(21) Appl. No.: 11/981,321

(22) Filed: Oct. 30, 2007

(30) Foreign Application Priority Data
Nov. 20, 2006 (DE) 10 2006 054 603.2

(51) Int. Cl. G01M 15/12; G06F 15/00; G01M 15/11

(52) U.S. Cl. 702/183; 73/114.07; 73/114.79

(57) ABSTRACT

A method for diagnosing an internal combustion engine including at least one microphone associated with the internal combustion engine, the sound of the internal combustion engine being recorded and converted into an electrical signal. The electrical signal representing the sound is used for the diagnosis of the operating state of the internal combustion engine.

### FIELD OF THE INVENTION

The present invention relates to a method and a device, as well as a computer program, for diagnosing an internal combustion engine having at least one microphone associated with the internal combustion engine.

### BACKGROUND INFORMATION

The operating state of an internal combustion engine is usually diagnosed by measuring and evaluating different physical quantities such as crankshaft speed, different pressures and temperatures, and the like.

European patent document EP 0 840 285 refers to a system for active exhaust sound dampening of an internal combustion engine. Systems of this type generate a sound signal, for example, with the aid of a speaker, which is superimposed on the sound generated by the exhaust gas system, compensating it or changing it via “sound design.” Part of the system is a microphone for receiving the sound emitted by the exhaust gas system (exhaust noise).

### SUMMARY OF THE INVENTION

One object of the exemplary embodiments and/or exemplary methods of the present invention is to provide further options for the diagnosis of the operating state of an internal combustion engine.

This object is achieved by a method, a device, and a computer program, and the use of a device according to the independent claims.

The object is achieved in particular by a method for diagnosing an internal combustion engine having at least one microphone associated with the internal combustion engine, the sound being recorded and converted into an electrical signal, the electrical signal representing the sound being used for the diagnosis of the operating state of the internal combustion engine. The diagnosis of the operating state includes the detection of damage to individual components or modules of the internal combustion engine and monitoring whether the actual state of the internal combustion engine corresponds to a setpoint state, for example, whether a cylinder shutdown has been properly performed, whether parameters such as injection time and injection duration, ignition time, and the like correspond to the setpoint quantities. The internal combustion engine may be situated in a motor vehicle. The microphone may be associated with an exhaust gas system. The microphone may be part of a device for actively controlling the sound of the exhaust gas system. The diagnosis of the operating state may take place using the raw data of the microphone conditioned by a control unit of the device for actively controlling the sound of the exhaust gas system. The microphone may, however, be also situated at other locations of the engine or the vehicle, which may be in the proximity of the internal combustion engine to be monitored. Conditioning may include digitizing and/or filtering and/or transformation into the frequency range.

It may be provided that the diagnosis of the operating state takes place with the help of a comparison of the electrical signal representing the sound of the exhaust gas system with an expected electrical signal, and in the event of a deviation of the electrical signal representing the sound of the exhaust gas system from the expected electrical signal greater than a limiting value, a deviation of the operating state of the internal combustion engine from a setpoint state is recognized. The diagnosis of the operating state of the internal combustion engine may include the detection of combustion misses. A combustion miss may be detected when an amplitude of an exhaust gas pulsation during a certain period of time is less than an expected minimum amplitude. In another exemplary embodiment, the diagnosis of the operating state of the internal combustion engine includes monitoring of the opening and closing of gas exchange valves. The diagnosis of the operating state of the internal combustion engine may include monitoring of at least one cylinder during a shutoff of this cylinder for closed gas exchange valves. An erroneous opening of a gas exchange valve during a shutoff of a cylinder may be detected when an amplitude of an exhaust gas pulsation during a certain period of time is greater than an expected maximum amplitude.

It may be provided that a noise pattern representing the signal is generated from the electrical signal, which is compared with noise patterns characteristic for certain errors, a measure which represents the degree of agreement between the noise pattern representing the signal and the characteristic noise pattern is ascertained and the error associated with the characteristic noise pattern is recognized when the measure is outside a tolerance range. The measure representing the degree of agreement between the noise pattern representing the signal and the characteristic noise pattern may be, for example, a correlation between the two noise patterns or a comparable statistical variable.

The noise pattern may be a spectrum of the electrical signal in the frequency range of an integral transform, in particular a Fourier transform.

The above-named object is also achieved by the use of a unit, in particular a control unit for an internal combustion engine which is designed for carrying out a method according to the present invention.

The above-named object is also achieved via a computer program having program code for carrying out all operations or tasks of a method according to the present invention when the program is executed on a computer.

The above-named object is also achieved by the use of a device for actively controlling the sound of the exhaust gas system of an internal combustion engine for carrying out a method according to the present invention.

An exemplary embodiment of the present invention is explained below in greater detail with reference to the appended drawings and description herein.

### BRIEF DESCRIPTION OF THE DRAWINGS

FIG. 1 schematically shows a system for actively controlling the sound in the exhaust gas system of an internal combustion engine.

FIG. 2 shows, in detail, a system according to the exemplary embodiments and/or exemplary methods of the present invention for diagnosing an internal combustion engine.

### DETAILED DESCRIPTION

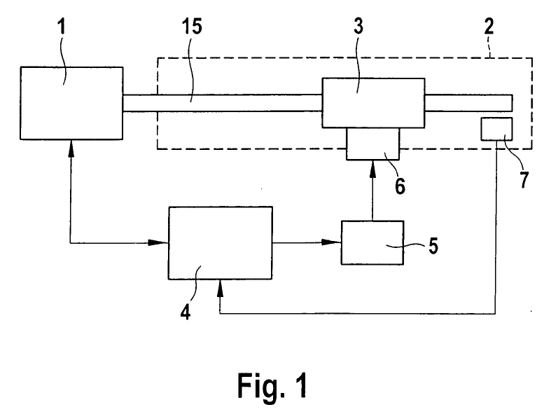

FIG. 1 schematically shows a system for actively controlling exhaust gas system 2 of an internal combustion engine. A detailed description of a system of this type can be found in EP 0 840 285 and in the article “Variable Gestaltung des Abgasmündungsgeräusches am Beispiel eines V6-Motors” [Variable formation of the exhaust discharge noise in a V6 engine as an example] by Heil, Enderle et al. in MTZ 10/2001, pp. 786-794. An internal combustion engine 1 is connected to an exhaust gas system which includes a pipe 15 and a muffler 3. The internal combustion engine and the system for actively controlling the sound are controlled using a control unit 4 known from the related art. For actively controlling the sound, control unit 4 generates a signal which is amplified by amplifier 5 to the required power and injected into muffler 3 via a sound converter 6, which may be a speaker. The calculation of the signal uses variables which describe the operating point of the internal combustion engine. In order to perform a regulation, the resulting sound signal at the outlet of the exhaust gas system is detected by a microphone 7 and supplied to engine control unit 4 as an electrical quantity. The electrical quantity of microphone 7 representing the sound signal at the outlet of the exhaust gas system is used by the control unit for controlling and regulating the signals of sound converter 6.

To control the sound signal, control unit 4 has a calculation formula, which may be interpreted in the general sense as a controller. The goal is either to minimize the signal from microphone 7 (i.e., the goal of the regulation in this case is minimum noise) or to achieve a desired amplitude of certain frequencies (i.e., the goal of the regulation in this case is “noise design” and thus deliberate influencing of the noise character). For this purpose, the controller contains parameters which are stored in control unit 4 as a function of the operating point. This function may be, for example, engine speed n, engine load P, and ignition angle φ. These parameters are either fixedly predefined or are adapted to changing parameters of the system to be regulated via adaptation.

It is now provided according to the exemplary embodiments and/or exemplary methods of the present invention that the system for actively controlling the sound be used for the diagnosis of the operating state of the internal combustion engine. In particular, the system for actively controlling the sound is used for monitoring the internal combustion engine for combustion misses of individual cylinders. The occurrence of combustion misses is monitored within a diagnostic function in the engine controller. This is, in particular, the failure of combustion to occur in one or more cylinders, for example, due to a defect in the area of the ignition system of the internal combustion engine. On the other hand, monitoring of the controlled de-activation of individual cylinders, known as cylinder shut-off, is possible.

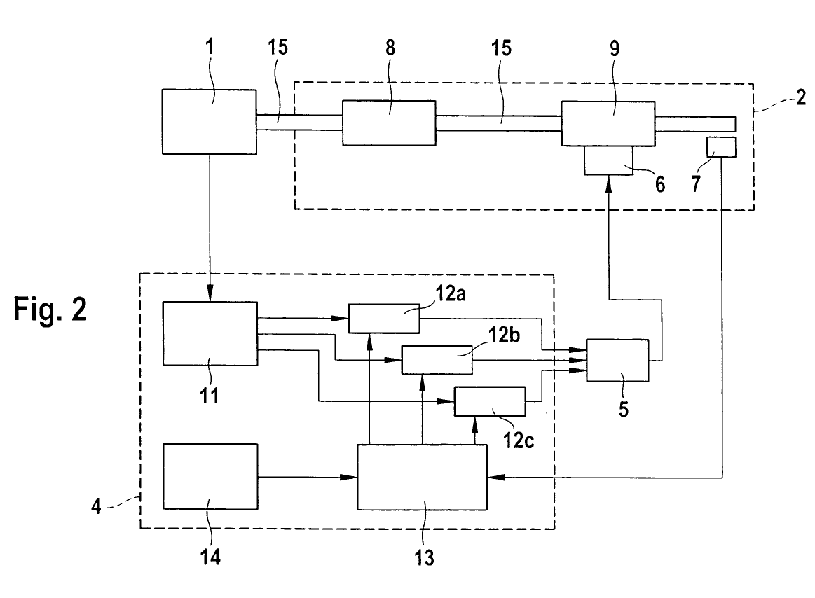

FIG. 2 shows a system according to the exemplary embodiments and/or exemplary methods of the present invention in detail. Internal combustion engine 1 is connected to an end muffler 9 via exhaust pipe 15, which includes an intermediate muffler 8. As FIG. 1 shows, end muffler 9 is associated with a speaker. As in the exemplary embodiment of FIG. 1, a microphone for recording the discharge noise of exhaust 10 is situated downstream from end muffler 9. A signal generator 11 generates the base frequency of the exhaust gas pulsations as a function of engine speed n; a crankshaft transducer may be used as a synchronization source for this purpose.

Signal generator 11 also generates a desired number of multiples of the base frequencies, known as harmonics. These are individually controlled in amplification and phase angle using digital filters, here represented for three frequencies, i.e., the base frequency and two harmonics, and are provided with reference numerals 12a, 12b, and 12c. The filter parameters are, on the one hand, stored in control unit 4 as a function of the operating point; on the other hand, they are corrected via an adaptation device 13 performing an adaptation algorithm, in such a way that the deviations between the signal of microphone 7 and predefinable setpoint values 14 of the amplitude become minimum for each of the frequencies. The output signals of filters 12a through 12c are supplied to a power amplifier 5, which activates a sound converter 6, which, for example, may be a speaker or the like. The adaptation algorithm of adaptation device 10 may, for example, minimize a quadratic quality criterion which is [performed] using a least-square method.

If the filter parameters of digital filters 12a through 12c are ideally adapted and setpoint value 14 is set to zero, this corresponds to the regulation goal of a minimum noise at the outlet of the exhaust gas system; the sound signal of the sound converter thus compensates the exhaust gas pulsations of the individual cylinders almost completely. The output signal of microphone 7 is then almost zero. The failure of a combustion to occur, i.e., a combustion miss, means a significantly smaller amplitude of the exhaust gas pulsation for this cylinder. For the exhaust gas pulsation of a full combustion, the correction signal of sound converter 6 is, however, determined by the filter parameters of digital filters 12a through 12c, which are therefore also controlled by the operating point of the internal combustion engine. A signal amplitude thus appears at microphone 7.

This signal may now be analyzed using known methods. One available method is an adjustable threshold value being exceeded, in which case a combustion miss is inferred. The combustion miss is associated with a certain cylinder by measuring the propagation time of the exhaust gas pulsation from the exhaust valve of the internal combustion engine to microphone 7. This propagation time is essentially determined by the exhaust gas temperature and its effect on the velocity of sound, i.e., if this propagation time is stored in control unit 4 in a characteristics map, the misfiring cylinder may be inferred if engine speed n is known. A combustion miss is detected when amplitude A of the exhaust gas pulsation during a certain period of time Δt is less than an expected minimum amplitude A_min.

In another embodiment, the system is used for monitoring the controlled deactivation of one of the cylinders. In doing this, the engine controller does not supply individual cylinders with fuel as a function of the operating point. Furthermore, the intake and exhaust valves (gas exchange valves) of the internal combustion engine are kept closed to reduce the energy consumption by the compression work. In the ideal case, the shut-off cylinders generate no exhaust gas pulsations. The filter parameters of filters 12a through 12c may now be switched over by the engine controller to parameters that depend on the goal of the regulation. If a minimum exhaust gas noise is set as the goal of the regulation, no output signal to sound converter 6 is required for the shut-off cylinder. However, if the exhaust gas noise is not to be affected by the cylinder deactivation, sound converter 6 appends the noise of the missing combustions to the overall noise.

In both above-mentioned cases, the signal at microphone 7 differs from the expected signal if the exhaust valves do not remain closed as requested by the engine controller. The behavior of the exhaust valve controller may thus be monitored without additional sensors. An erroneous opening of a gas exchange valve during a shutoff of a cylinder is detected when amplitude A of the exhaust gas pulsation during a certain period of time Δt is greater than an expected maximum amplitude A_max.

In another exemplary embodiment of the present invention, the control unit performs a signal analysis of the noise spectrum, for example, with the aid of a fast Fourier transform (FFT). These ascertained noise patterns are compared with stored noise patterns. Neural networks or even simple threshold value queries may be used here. The different noise patterns and their timing correspond to different error patterns such as knocking of the engine, a bearing failure at the engine or a wheel, a defect at an injector, a defect at the high-pressure pump, a defect at the generator, for example, a slipping V-belt, a defect at the starter, a leak at the intake or exhaust system, defects at other actuators such as the actuators of the throttle valve, secondary air pump, secondary air system, tank venting valve, exhaust valve, exhaust recirculation valve, intake manifold switchover, wear on the main or secondary transmissions, for example, in an automatic transmission, at the transfer case or the differential, a defect at the engine valve train, a defect at the waste gate of the turbocharger, a defect at the air recirculation valve of the turbocharger or a defect at the engine fan or the starter or the like.

In the case of an agreement between ascertained or measured noise patterns with the stored noise patterns, the error pattern associated with the stored noise pattern is inferred.

Alternatively, the diagnosis may be performed during engine coasting mode because in that case there is no interfering noise from the combustion. The diagnosis may also be performed with the vehicle at a standstill. In doing so, components of the internal combustion engine or other components of the vehicle are deliberately activated with the internal combustion engine stopped, and the noises imitated by the components are analyzed. The injectors may also be activated as a function of the noise level of the component. For example, a reduction of the “knocking noise,” in particular of a diesel engine, may occur due to a change in the activation and thus a change in the injected quantity. This means that the injection control is modified in such a way that the noise is reduced. Component drifts may also be compensated for over their service life by such a regulating circuit. During coasting mode the ignition may also be monitored by monitoring the noise of the ignition spark.

What is claimed is:

1. A method for diagnosing an internal combustion engine, the method comprising:
recording, using at least one microphone associated with the internal combustion engine, a sound of the internal combustion engine, and converting it into an electrical signal; and
diagnosing an operating state of the internal combustion engine using the electrical signal representing the sound.

2. The method of claim 1, wherein the microphone is associated with an exhaust gas system.

3. The method of claim 1, wherein the microphone is part of a device for actively controlling the sound of the exhaust gas system.

4. The method of claim 3, wherein the diagnosis of the operating state takes place using raw data of the microphone conditioned by a control unit of the device for actively controlling the sound of the exhaust gas system.

5. The method of claim 1, wherein the diagnosis of the operating state takes place using a comparison of the electrical signal representing the sound of the exhaust gas system with an expected electrical signal, and if a deviation of the electrical signal representing the sound of the exhaust gas system from the expected electrical signal is greater than a limiting value, then a deviation of the operating state of the internal combustion engine from a setpoint state is recognized.

6. The method of claim 1, wherein the diagnosis of the operating state of the internal combustion engine includes detecting combustion misses.

7. The method of claim 6, wherein the combustion miss is detected when an amplitude of an exhaust gas pulsation during a certain period of time is less than an expected minimum amplitude.

8. The method of claim 1, wherein the diagnosis of the operating state of the internal combustion engine includes monitoring an opening and a closing of gas exchange valves.

9. The method of claim 8, wherein the diagnosis of the operating state of the internal combustion engine includes monitoring at least one cylinder during a shutoff of the at least one cylinder for closed gas exchange valves.

10. The method of claim 9, wherein an erroneous opening of a gas exchange valve during a shutoff of a cylinder is recognized when an amplitude of an exhaust gas pulsation during a certain period of time is greater than an expected maximum amplitude.

11. The method of claim 1, wherein:
a noise pattern representing the signal is generated from the electrical signal, which is compared with noise patterns characteristic of certain errors,
a measure which represents a degree of agreement between the noise pattern representing the signal and the characteristic noise pattern is ascertained, and
an error associated with a characteristic noise pattern is recognized when the measure is outside a tolerance range.

12. The method of claim 11, wherein the noise pattern is a spectrum of an electrical signal in a frequency range of an integral transform or a Fourier transform.

13. A device for diagnosing an internal combustion engine, comprising:
a recording arrangement to record, using at least one microphone associated with the internal combustion engine, a sound of the internal combustion engine, and converting it into an electrical signal; and
a diagnosing arrangement to diagnose an operating state of the internal combustion engine using the electrical signal representing the sound.

14. A computer readable medium having a program executable by a processor, comprising:
program code for diagnosing an internal combustion engine by performing the following:
recording, using at least one microphone associated with the internal combustion engine, a sound of the internal combustion engine, and converting it into an electrical signal; and
diagnosing an operating state of the internal combustion engine using the electrical signal representing the sound.

15. A system for actively controlling the sound of the exhaust gas system of an internal combustion engine, comprising:
a device for diagnosing an internal combustion engine, including:
a recording arrangement to record, using at least one microphone associated with the internal combustion engine, a sound of the internal combustion engine, and converting it into an electrical signal; and
a diagnosing arrangement to diagnose an operating state of the internal combustion engine using the electrical signal representing the sound.
